(19) United States
(12) Patent Application Publication
(10) Pub. No.: US 2014/0148996 A1
(43) Pub. Date: May 29, 2014

(54) SYSTEM FOR ADJUSTING THE VISIBLE LIGHT TRANSMISSION LEVEL OF A WINDOW

(71) Applicant: James Wilbert Watkins, Jacksonville, FL (US)

(72) Inventor: James Wilbert Watkins, Jacksonville, FL (US)

(21) Appl. No.: 14/091,193

(22) Filed: Nov. 26, 2013

Related U.S. Application Data
(60) Provisional application No. 61/729,916, filed on Nov. 26, 2012.

(51) Int. Cl. B60J 3/04

(52) U.S. Cl. CPC B60J 3/04
USPC 701/36

(57) ABSTRACT

A system for adjusting the visible light transmission level of a vehicle's window is provided. The present invention may include a processor, a memory to store preset data, a global positioning system (GPS) to indicate where the user is located, and a tint adjuster to change the tint of user's windows on a vehicle. Therefore, when a user crosses state lines, the GPS may recognize this and the processor may select the preset tint level loaded on the memory, the preset tint level being the VLT limit of the particular state that the user has entered.

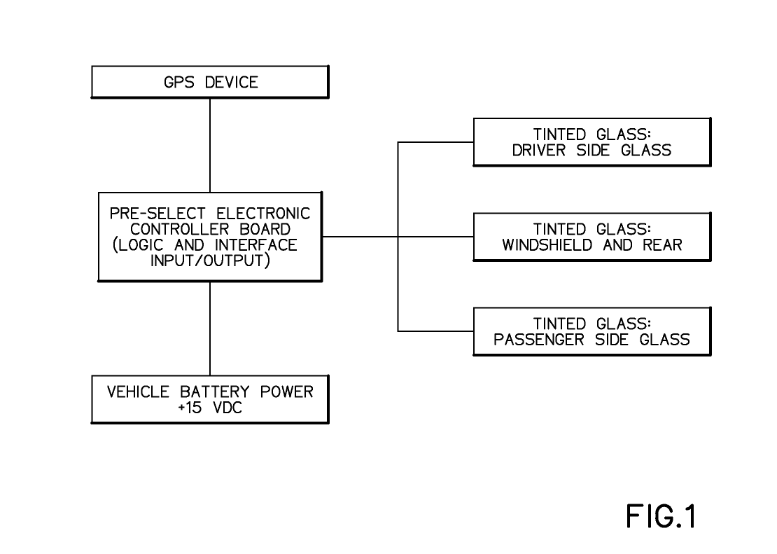

### CROSS-REFERENCE TO RELATED APPLICATION

This application claims the benefit of priority of U.S. provisional application No. 61/729,916, filed Nov. 26, 2012, the contents of which are herein incorporated by reference.

### BACKGROUND OF THE INVENTION

The present invention relates to a tint adjuster and, more particularly, to a system for adjusting the visible light transmission level of a vehicle's window.

Automobile window tinting reduces the visible light transmission (VLT) through car windows. This can be problematic at night, when motorists must be able to see through the windows of other vehicles in order to spot hazards which would otherwise be obstructed. Police also may want to be able to identify the passengers in a vehicle.

In many jurisdictions, there are laws to ensure darkness of films do not present a danger to motorists. The legal VLT levels vary from state to state. Therefore, users that have fixed tinted windows may have issues during interstate travel. For example, a user may have a legal VLT tint level in Rhode Island but may have an illegal VLT tint level in Massachusetts.

As can be seen, there is a need for a system that adjusts the VLT of a user's car to the legal level.

### SUMMARY OF THE INVENTION

In one aspect of the present invention, a system for adjusting the visible light transmission level of a vehicle's window comprises: a computer comprising a processor and a memory, wherein the memory stores data comprising a plurality of preset visible light transmission levels, wherein each visible light transmission level is linked with a location; a global positioning system operatively connected to the computer; and a tint adjuster operatively connected to at least one window of the vehicle, wherein the global positioning system detects the location of the vehicle and the tint adjuster adjusts the visible light transmission level of the at least one window based on the location of the vehicle.

In another aspect of the present invention, a system for adjusting the visible light transmission level of a vehicles window comprises: a computer comprising a processor and a memory, wherein the computer is operatively connected to a global positioning system; and a program product comprising machine-readable program code for causing, when executed, the computer to perform the following process steps: determining a location based on an output of the global position system; selecting a visible light transmission level from a plurality of visible light transmission levels stored in the memory, wherein the visible light transmission level selected is based on the determined location; and adjusting the visible light transmission level of at least one window of a vehicle to the selected visible light transmission level.

These and other features, aspects and advantages of the present invention will become better understood with reference to the following drawings, description and claims.

### BRIEF DESCRIPTION OF THE DRAWINGS

The FIGURE is a system block diagram of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes at least one computer. The computer may be within a vehicle. The computer may include a program product including a machine-readable program code for causing, when executed, the computer to perform steps. The program product may include software loaded onto the memory of the computer or uploaded wirelessly to the computer. The computer may access the software via the web browser using the Bluetooth ® technology, global positioning system technology, the internet, extranet, intranet, host server, internet cloud and the like.

The present invention may include a system and method for an automatic tint adjuster using automated navigational equipment. The present invention may include a processor, a memory to store preset data, a global positioning system (GPS) to indicate where the user is located, and an automatic tinting mechanism to change the tint of user's windows. Therefore, when a user crosses state lines, the GPS may recognize this and the processor may select the preset tint level loaded on the memory, the preset tint level being the VLT limit of the particular state that the user has entered. The automatic tinting mechanism may then be activated to change the tint to the VLT limit the processor selected. Therefore, a user will not be pulled over for having an incorrect VLT in the states that the user travels.

Referring to the FIGURE, the present invention includes a computer having a processor and memory. The computer may be an electronic controller board with a logic and interface input and output. The memory of the computer stores data. The data includes a plurality of preset visible light transmission (VLT) levels. Each VLT level is linked with a location. The present invention may further include a global positioning system (GPS) operatively connected to the computer. The present invention may further include a tint adjuster operatively connected to at least one window of a vehicle. The GPS detects the location of the vehicle and the tint adjuster adjusts the VLT level of the at least one window based on the location of the vehicle. The tint adjuster, GPS, computer and any other powered mechanism may be connected to the vehicle battery.

The location of the present invention may include a plurality of sub-entities within at least one county. For example, the laws of each state within the United States of America may vary with regard to the level of VLT permitted. Therefore, the plurality of preset VLT levels may be based on the plurality of laws of the states within the United States of America. The percentage of VLT permitted within the states is demonstrated in the graph below:

| State | VLT |
|---|---|
| Alabama | 32% |
| Alaska | 70% |
| Arizona | 30% |
| Arkansas | 25% |
| California | 70% |
| Colorado | 27% |
| Connecticut | 35% |
| Delaware | 70% |
| Florida | 28% |
| Georgia | 32% |
| Hawaii | 35% |
| Idaho | 35% |
| Illinois | 35% |
| Indiana | 30% |
| Iowa | 70% |
| Kansas | 35% |
| Kentucky | 35% |
| Louisiana | 40% |
| Maine | 35% |
| Maryland | 35% |
| Massachusetts | 35% |
| Michigan | 70% |
| Minnesota | 50% |
| Mississippi | 28% |
| Missouri | 35% |
| Montana | 24% |
| Nebraska | 35% |
| Nevada | 35% |
| New Hampshire | 70% |
| New Jersey | 70% |
| New Mexico | 20% |
| New York | 70% |
| North Carolina | 35% |
| North Dakota | 50% |
| Ohio | 50% |
| Oklahoma | 25% |
| Oregon | 35% |
| Pennsylvania | 70% |
| Rhode Island | 70% |
| South Carolina | 27% |
| South Dakota | 35% |
| Tennessee | 35% |
| Texas | 25% |
| Utah | 43% |
| Vermont | 70% |
| Virginia | 35% |
| Washington | 24% |
| West Virginia | 35% |
| Wisconsin | 50% |
| Wyoming | 28% |
| District of Columbia | 70% |

Therefore, in certain embodiments, the data from the chart above may be uploaded to the memory of the computer. The vehicle may be driving in Delaware and have a VLT level of 70%. The vehicle may cross state lines into Maryland. The GPS of the present invention may recognize that the vehicle is crossing over into Maryland, which may activate the tint adjuster to adjust the tint of the windows to a 35% VLT level. Thus, the present invention may change the tint of the windows of the car to a level which is legal within the state the vehicle is in, preventing the user from breaking the law.

The tint adjuster of the present invention may include a manual and an automatic tint adjuster. In certain embodiments, when a manual tint adjuster is used, the drive of the vehicle may be notified that they have traveled across state lines. The VLT level may be communicated to the driver and the driver may manually change the tint of the windows using the tint adjuster. In certain embodiments, when an automatic tint adjuster is used, the computer may communicate with the tint adjuster to automatically adjust the tint to the preset level when state lines have been crossed.

As mentioned above the present invention may include a program product comprising machine-readable program code for causing, when executed, the computer to perform the process steps. The steps of the present invention may include: determining a location based on the output of the global position system; selecting a visible light transmission level from a plurality of visible light transmission levels stored in the memory, wherein the visible light transmission level selected is based on the determined location; and adjusting the visible light transmission level of at least one window of a vehicle based on the selected visible light transmission level.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for adjusting the visible light transmission level of a vehicle's window comprising:
a computer comprising a processor and a memory, wherein the memory stores data comprising a plurality of preset visible light transmission levels, wherein each visible light transmission level is linked with a location;
a global positioning system operatively connected to the computer; and
a tint adjuster operatively connected to at least one window of the vehicle,
wherein the global positioning system detects the location of the vehicle and the tint adjuster adjusts the visible light transmission level of the at least one window based on the location of the vehicle.

2. The system of claim 1, wherein the location comprises a plurality of sub-entities within at least one country.

3. The system of claim 2, wherein the plurality of preset visible light transmission levels is based on a plurality of laws of the plurality of sub-entities within the at least one country.

4. The system of claim 3, wherein the plurality of sub-entities is individual states within the United States of America.

5. The system of claim 1, wherein the at least one window comprises at least one of a driver's side door window, a passenger's side door window, a rear windshield, and a front windshield.

6. The system of claim 1, wherein the tint adjuster is at least one of an automatic tint adjuster and a manual tint adjuster.

7. A system for adjusting the visible light transmission level of a vehicles window comprising:
a computer comprising a processor and a memory, wherein the computer is operatively connected to a global positioning system; and
a program product comprising machine-readable program code for causing, when executed, the computer to perform the following process steps:
determining a location based on an output of the global position system;
selecting a visible light transmission level from a plurality of visible light transmission levels stored in the memory, wherein the visible light transmission level selected is based on the determined location; and
adjusting the visible light transmission level of at least one window of a vehicle to the selected visible light transmission level.
